(19) United States
(12) Patent Application Publication
(10) Pub. No.: US 2021/0240761 A1
(43) Pub. Date: Aug. 5, 2021

(54) METHOD AND DEVICE FOR CROSS-MODAL INFORMATION RETRIEVAL, AND STORAGE MEDIUM

(71) Applicant: SHENZHEN SENSETIME TECHNOLOGY CO., LTD., Shenzhen (CN)

(72) Inventors: Zihao WANG, Shenzhen (CN); Jing Shao, Shenzhen (CN); Hongsheng Li, Shenzhen (CN); Junjie Yan, Shenzhen (CN); Xiaogang Wang, Shenzhen (CN); Lv Sheng, Shenzhen (CN)

(21) Appl. No.: 17/239,974

(22) Filed: Apr. 26, 2021

Related U.S. Application Data
(63) Continuation of application No. PCT/CN2019/083725, filed on Apr. 22, 2019.

(30) Foreign Application Priority Data
Jan. 31, 2019 (CN) 201910109983.5

(51) Int. Cl. G06F 16/56; G06F 16/33; G06N 3/04; G06F 40/30; G06K 9/62

(52) U.S. Cl. CPC G06F 16/56; G06F 16/3347; G06K 9/629; G06F 40/30; G06K 9/6215; G06N 3/0454

(57) ABSTRACT

A method for cross-modal information retrieval is as follows. First modal information and second modal information are acquired. A first semantic feature of the first modal information and a first attention feature of the first modal information are determined according to a modal feature of the first modal information. A second semantic feature of the second modal information and a second attention feature of the second modal information are determined according to a modal feature of the second modal information. A similarity between the first modal information and the second modal information are determined based on the first attention feature, the second attention feature, the first semantic feature, and the second semantic feature.

### CROSS-REFERENCE TO RELATED APPLICATIONS

This application is a continuation of International Application No. PCT/CN2019/083725, filed on Apr. 22, 2019, which per se is based on and claims benefit of priority to Chinese Application No. 201910109983.5, titled METHOD AND DEVICE FOR CROSS-MODAL INFORMATION RETRIEVAL, AND STORAGE MEDIUM, filed before SIPO on Jan. 31, 2019. The disclosures of International Application No. PCT/CN2019/083725 and Chinese Application No. 201910109983.5 are hereby incorporated by reference in their entireties.

### TECHNICAL FIELD

The subject disclosure relates to the field of computers, and more particularly, to a method and device for cross-modal information retrieval, and a storage medium.

### BACKGROUND

With development of computer networks, a user may acquire a great amount of information from a network. Due to the huge amount of information, in general, the user may retrieve information of interest by inputting a text or a picture. With continuous optimization of information retrieval technology, a manner of cross-modal information retrieval emerges. In the manner of cross-modal information retrieval, a second modal sample with semantics similar to a first modal sample may be retrieved using the first modal sample. For example, a text corresponding to an image may be retrieved using the image. Alternatively, an image corresponding to a text may be retrieved using the text.

### SUMMARY

In view of this, embodiments herein provide a solution for cross-modal information retrieval.

According to a first aspect herein, a method for cross-modal information retrieval includes: acquiring first modal information and second modal information; determining a first semantic feature of the first modal information and a first attention feature of the first modal information according to a modal feature of the first modal information; determining a second semantic feature of the second modal information and a second attention feature of the second modal information according to a modal feature of the second modal information; and determining a similarity between the first modal information and the second modal information based on the first attention feature, the second attention feature, the first semantic feature, and the second semantic feature.

According to another aspect herein, a device for cross-modal information retrieval includes an acquiring module, a first determining module, a second determining module, and a similarity determining module. The acquiring module is adapted to acquiring first modal information and second modal information. The first determining module is adapted to determining a first semantic feature of the first modal information and a first attention feature of the first modal information according to a modal feature of the first modal information. The second determining module is adapted to determining a second semantic feature of the second modal information and a second attention feature of the second modal information according to a modal feature of the second modal information. The similarity determining module is adapted to determining a similarity between the first modal information and the second modal information based on the first attention feature, the second attention feature, the first semantic feature, and the second semantic feature.

According to another aspect herein, a device for cross-modal information retrieval includes a processor and memory. The memory may be adapted to storing an instruction executable by the processor. The processor may be adapted to implementing the method herein.

According to another aspect herein, a non-transitory computer-readable storage medium, having stored therein computer program instructions which, when executed by a processor, implement the method herein.

With embodiments herein, first modal information and second modal information are acquired. A first semantic feature of the first modal information and a first attention feature of the first modal information are determined respectively according to a modal feature of the first modal information. A second semantic feature of the second modal information and a second attention feature of the second modal information are determined respectively according to a modal feature of the second modal information. A similarity between the first modal information and the second modal information may be determined based on the first attention feature, the second attention feature, the first semantic feature, and the second semantic feature. Accordingly, a similarity between different modal information may be acquired using a semantic feature and an attention feature of the different modal information. Compared to prior art that relies a lot on quality of feature extraction, with embodiments herein, a semantic feature and an attention feature of different modal information are processed separately, reducing a degree of reliance on quality of feature extraction during cross-modal information retrieval. In addition, the method is simple, with low time complexity, improving efficiency in cross-modal information retrieval.

Other characteristics and aspects herein may become clear according to detailed description of exemplary embodiments made below with reference to the drawings.

### BRIEF DESCRIPTION OF THE ACCOMPANYING DRAWINGS

Drawings here are incorporated in and constitute part of the specification, illustrate, together with the specification, exemplary embodiments, characteristics, and aspects herein, and serve to explain the principle of the subject disclosure.

FIG. 1 is a flowchart of a method for cross-modal information retrieval according to an exemplary embodiment herein.

FIG. 2 is a flowchart of determining a first semantic feature and a first attention feature according to an exemplary embodiment herein.

FIG. 3 is a block diagram of a process of cross-modal information retrieval according to an exemplary embodiment herein.

FIG. 4 is a flowchart of determining a second semantic feature and a second attention feature according to an exemplary embodiment herein.

FIG. 5 is a block diagram of determining a matching retrieval result according to a similarity according to an exemplary embodiment herein.

FIG. 6 is a flowchart of cross-modal information retrieval according to an exemplary embodiment herein.

FIG. 7 is a block diagram of a device for cross-modal information retrieval according to an exemplary embodiment herein.

FIG. 8 is a block diagram of a device for cross-modal information retrieval according to an exemplary embodiment herein.

### DETAILED DESCRIPTION

Exemplary embodiments, characteristics, and aspects herein are elaborated below with reference to the drawings. Same reference signs in the drawings may represent elements with the same or similar functions. Although various aspects herein are illustrated in the drawings, the drawings are not necessarily to scale unless expressly pointed out otherwise.

The dedicated word “exemplary” may refer to “as an example or an embodiment, or for descriptive purpose”. Any embodiment illustrated herein as being “exemplary” should not be construed as being preferred to or better than another embodiment. Moreover, a great number of details are provided in embodiments below for a better understanding of the subject disclosure. A person having ordinary skill in the art may understand that the subject disclosure can be implemented without some details. In some embodiments, a method, means, an element, a circuit, etc., that is well-known to a person having ordinary skill in the art may not be elaborated in order to highlight the main point of the subject disclosure.

The following method, device, electronic equipment, or computer storage medium herein may be applied to any scene where cross-modal information retrieval is required, such as software retrieval, information location, etc. A specific scene of application is not limited herein. Any solution for retrieving cross-modal information using a method provided herein shall fall within the scope of the subject disclosure.

With a solution for cross-modal information retrieval provided herein, first modal information and second modal information are acquired respectively. A first semantic feature of the first modal information and a first attention feature of the first modal information are determined according to a modal feature of the first modal information. A second semantic feature of the second modal information and a second attention feature of the second modal information are determined according to a modal feature of the second modal information. As the first modal information and the second modal information are information of different modes, semantic features and attention features of the first modal information and the second modal information may be processed in parallel. Then, a similarity between the first modal information and the second modal information is determined based on the first attention feature, the second attention feature, the first semantic feature, and the second semantic feature. In such a manner, an attention feature may be decoupled from a semantic feature of modal information, and processed as a separate feature. In addition, the similarity between the first modal information and the second modal information may be determined with low time complexity, improving efficiency in cross-modal information retrieval.

In related art, accuracy in cross-modal information retrieval may be improved generally by improving quality of a semantic feature of modal information, instead of optimizing a feature similarity. Such a manner depends a lot on quality of a feature extracted from modal information, leading to low efficiency in cross-modal information retrieval. With embodiments herein, efficiency in cross-modal information retrieval is improved by optimizing a feature similarity, with low time complexity, improving efficiency in cross-modal information retrieval while ensuring accuracy in cross-modal information retrieval. The solution for cross-modal information retrieval provided herein is elaborated below with reference to the drawings.

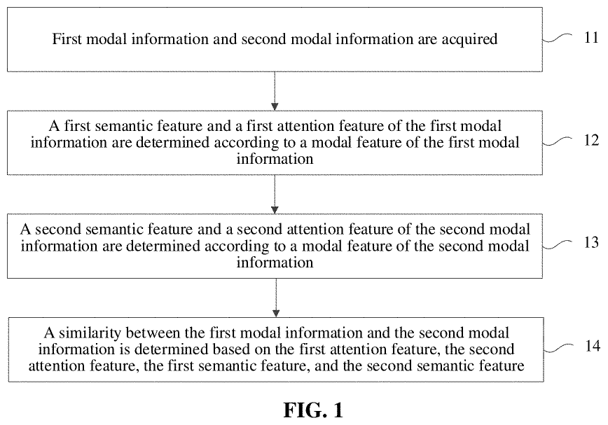

FIG. 1 is a flowchart of a method for cross-modal information retrieval according to an exemplary embodiment herein. As shown in FIG. 1, the method includes a step (steps) as follows.

In S11, first modal information and second modal information are acquired. In embodiments herein, a retrieval device (such as retrieval software, a retrieval platform, a retrieval server, etc.) may acquire first modal information or second modal information. For example, the retrieval device may acquire first modal information or second modal information transmitted by user equipment. As another example, the retrieval device may acquire first modal information or second modal information according to a user operation. A retrieval platform may also acquire first modal information or second modal information from a local storage or a database. Here, first modal information and second modal information may be information of different modes. For example, first modal information may include any one of text information or image information. Second modal information may include any one of text information or image information. Here, first modal information and second modal information are not limited to image information and text information, but may also include voice information, video information, optical signal information, etc. Here, a mode may be understood as a form of existence, or a type, of information. The first modal information and the second modal information may be information of different modes.

In S12, a first semantic feature of the first modal information and a first attention feature of the first modal information are determined according to a modal feature of the first modal information.

Here, after acquiring first modal information, a retrieval device may determine a modal feature of the first modal information. Modal features of the first modal information may form a first modal feature vector. Then, a first semantic feature of the first modal information and a first attention feature of the first modal information may be determined according to the first modal feature vector. A first semantic feature may include first branch semantic features and a first overall semantic feature. A first attention feature may include first branch attention features and a first overall attention feature. The first semantic feature may represent semantics of the first modal information. The first attention feature may represent attention of the first modal information. Here, the attention may be understood as a processing resource invested for processing an information unit of a certain part in the modal information when the modal information is being processed. Taking text information as an example, a noun in the text information, such as “red”, “shirt”, etc., may get more attention than a conjunction in the text information, such as “and”, “or”, etc.

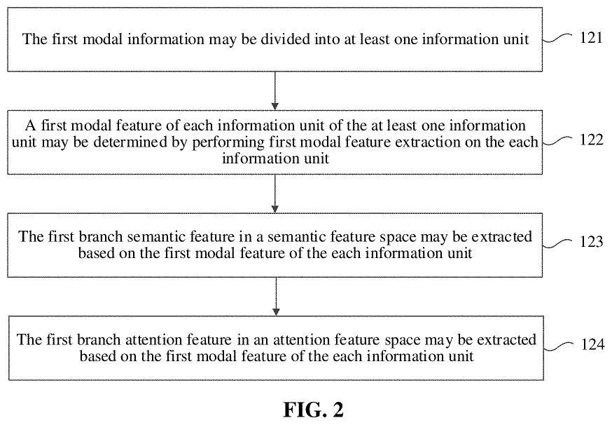

FIG. 2 is a flowchart of determining a first semantic feature and a first attention feature according to an exemplary embodiment herein. In a possible implementation, the first semantic feature of the first modal information and the first attention feature of the first modal information may be determined according to the modal feature of the first modal information as follows.

In S121, the first modal information may be divided into at least one information unit.

In S122, a first modal feature of each information unit of the at least one information unit may be determined by performing first modal feature extraction on the each information unit.

In S123, the first branch semantic feature in a semantic feature space may be extracted based on the first modal feature of the each information unit.

In S124, the first branch attention feature in an attention feature space may be extracted based on the first modal feature of the each information unit.

Here, in determining the first semantic feature of the first modal information and the first attention feature of the first modal information, the first modal information may be divided into multiple information units. The first modal information may be divided according to a preset information unit size, into information units of equal sizes, for example. Alternatively, the first modal information may be divided into multiple information units of different sizes. For example, when the first modal information is image information, an image may be divided into multiple image units. After the first modal information has been divided into multiple information units, first modal feature extraction may be performed on each information unit, acquiring the first modal feature of the each information unit. The first modal feature of the each information unit may form a first modal feature vector. Then, the first modal feature vector may be converted into a first branch semantic feature vector in the semantic feature space. The first modal feature vector may be converted into the first branch attention feature in the attention space.

In a possible implementation, a first overall semantic feature may be determined according to a first branch semantic feature of the first modal information. A first overall attention feature may be determined according to a first branch attention feature of the first modal information. Here, the first modal information may include multiple information units. The first branch semantic feature may represent a semantic feature corresponding to each information unit of the first modal information. The first overall semantic feature may represent a semantic feature corresponding to the first modal information. The first branch attention feature may represent an attention feature corresponding to each information unit of the first modal information. The first overall attention feature may represent an attention feature corresponding to the first modal information.

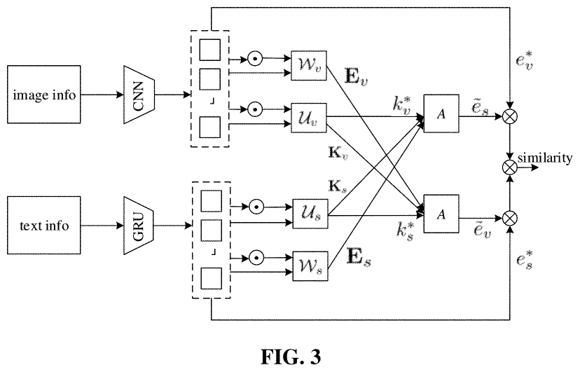

FIG. 3 is a block diagram of a process of cross-modal information retrieval according to an exemplary embodiment herein. For example, the first modal information may be image information. After acquiring the image information, the retrieval device may divide the image information into multiple image units, and then may extract an image feature of each image unit using a Convolutional Neural Network (CNN) model, generating an image feature vector (an example of the first modal feature) of each image unit. An image feature vector of an image unit may be expressed by a formula (1).

V=[v₁, v₂, . . . , vᵢ, . . . , v_{R}]∈ [symbol] ^{d×R} (1)

The R may be a number of the image units. The d may be a dimension of the image feature vector. The vᵢ may be the image feature vector of the ith image unit. The [symbol] may represent a real matrix. For image information, an image feature vector corresponding to the image information may be expressed by a formula (2).

$$v ° = \frac{1}{R} {{\sum }_{i}}^{R} {v}_{j} ∈ {ℝ}^{d \times 1} \qquad ( 2 )$$

Then, a first branch semantic feature of the image information may be acquired by linearly mapping the image feature vector of each image unit. A linear mapping function here may be expressed by Wᵥ. A first branch semantic feature vector corresponding to the first branch semantic feature of the image information may be expressed by a formula (3).

Eᵥ=Wᵥ^{T}V (3)

Correspondingly, a first overall semantic feature vector e*ᵥ formed by a first overall semantic feature of the image information may be acquired by linearly mapping the in the same manner.

Correspondingly, the retrieval device may linearly map the image feature vector of each image unit, acquiring a first branch attention feature of the image information. A linear function for attention feature mapping may be expressed by Uᵥ. A first branch attention feature vector corresponding to the first branch attention feature of the image information may be expressed by a formula (4).

Kᵥ=Uᵥ^{T}V (4)

Correspondingly, a first overall attention feature k*ᵥ of the image information may be acquired by linearly mapping the −v* in the same manner.

In S13, a second semantic feature of the second modal information and a second attention feature of the second modal information are determined according to a modal feature of the second modal information.

Here, after acquiring second modal information, a retrieval device may determine a modal feature of the second modal information. Modal features of the second modal information may form a second modal feature vector. Then, the retrieval device may determine a second semantic feature of the second modal information and a second attention feature of the second modal information according to the second modal feature vector. A second semantic feature may include second branch semantic features and a second overall semantic feature. A second attention feature may include second branch attention features and a second overall attention feature. The second semantic feature may represent semantics of the second modal information. The second attention feature may represent attention of the second modal information. The first semantic feature and the second semantic feature may correspond to the same feature space.

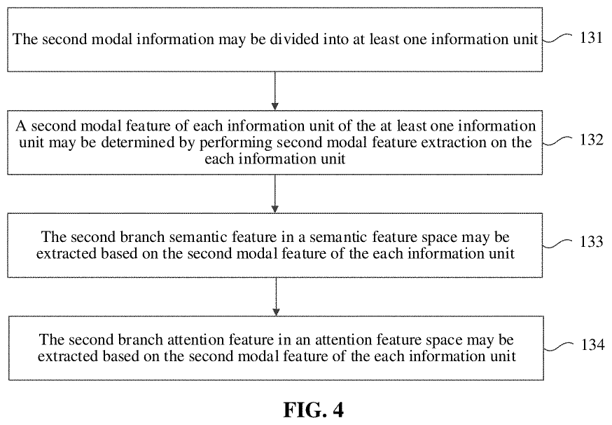

FIG. 4 is a flowchart of determining a second semantic feature and a second attention feature according to an exemplary embodiment herein. In a possible implementation, the second semantic feature of the second modal information and the second attention feature of the second modal information may be determined according to the modal feature of the second modal information as follows.

In S131, the second modal information may be divided into at least one information unit.

In S132, a second modal feature of each information unit of the at least one information unit may be determined by performing second modal feature extraction on the each information unit.

In S133, a second branch semantic feature in a semantic feature space may be extracted based on the second modal feature of the each information unit.

In S134, the second branch attention feature in an attention feature space may be extracted based on the second modal feature of the each information unit.

Here, in determining the second semantic feature of the second modal information and the second attention feature of the second modal information, the second modal information may be divided into multiple information units. The second modal information may be divided according to a preset information unit size, into information units of equal sizes, for example. Alternatively, the second modal information may be divided into multiple information units of different sizes. For example, when the second modal information is text information, a text may be divided into text units, with each word being a text unit. After the second modal information has been divided into multiple information units, second modal feature extraction may be performed on each information unit, acquiring the second modal feature of the each information unit. The second modal feature of the each information unit may form a second modal feature vector. Then, the second modal feature vector may be converted into a second branch semantic feature vector in the semantic feature space. The second modal feature vector may be converted into the second branch attention feature in the attention space. Here, the semantic feature space corresponding to the second semantic feature may be same as the semantic feature space corresponding to the first semantic feature. Here, feature spaces being the same may be understood as that feature vectors corresponding to the features are of the same dimension.

In a possible implementation, a second overall semantic feature may be determined according to a second branch semantic feature of the second modal information. A second overall attention feature may be determined according to a second branch attention feature of the second modal information. Here, the second modal information may include multiple information units. The second branch semantic feature may represent a semantic feature corresponding to each information unit of the second modal information. The second overall semantic feature may represent a semantic feature corresponding to the second modal information. The second branch attention feature may represent an attention feature corresponding to each information unit of the second modal information. The second overall attention feature may represent an attention feature corresponding to the second modal information.

As shown in FIG. 3, for example, the second modal information may be text information. After acquiring the text information, the retrieval device may divide the text information into multiple text units, such as by taking each word in the text information as a text unit, and then may extract a text feature of each text unit using a Gated Recurrent Unit (GRU) model, generating a text feature vector (an example of the second modal feature) of each text unit. A text feature vector of a text unit may be expressed by a formula (5).

S=[s₁, s₂, . . . , sⱼ, . . . , s_{T}]∈ [symbol] ^{d×T} (5)

The T may be a number of the text units. The d may be a dimension of the text feature vector. The sⱼ may be the text feature vector of the jth text unit. For text information, a text feature vector corresponding to the whole text information may be expressed by a formula (6).

$$s ° = \frac{1}{T} {{\sum }_{j}}^{T} {s}_{j} ∈ {ℝ}^{d \times 1} \qquad ( 6 )$$

Then, a second branch semantic feature of the text information may be acquired by linearly mapping the text feature vector of each text unit. A linear mapping function here may be expressed by Wₛ. A second semantic feature vector of the second semantic feature of the text information may be expressed by a formula (7).

E_{S}=W_{S}^{T}S (7)

Correspondingly, a second overall semantic feature vector e*_{S} formed by a second overall semantic feature of the text information may be acquired by linearly mapping the in the same manner.

Correspondingly, the retrieval device may linearly map the text feature vector of each text unit, acquiring a second branch attention feature of the text information. A linear function for attention feature mapping may be expressed by Uₛ. A second branch attention feature vector corresponding to the second branch attention feature of the text information may be expressed by a formula (8).

K_{S}=U_{S}^{T}S (8)

Correspondingly, a second overall attention feature vector k*ₛ formed by a second overall attention feature of the text information may be acquired by linearly mapping the s* in the same manner.

In 14, a similarity between the first modal information and the second modal information is determined based on the first attention feature, the second attention feature, the first semantic feature, and the second semantic feature.

In embodiments herein, the retrieval device may determine correlated attention between the first modal information and the second modal information according to the first attention feature of the first modal information and the second attention feature of the second modal information. Then, if the first semantic feature is combined, a semantic feature of attention of the second modal information to the first modal information may be determined. If the second semantic feature is combined, a semantic feature of attention of the first modal information to the second modal information may be determined. In such a manner, the similarity between the first modal information and the second modal information may be determined according to the semantic feature of attention of the second modal information to the first modal information and the semantic feature of attention of the first modal information to the second modal information. The similarity between the first modal information and the second modal information may be determined by computing a cosine distance or through a dot product operation.

In a possible implementation, in determining the similarity between the first modal information and the second modal information, first attention information may be determined according to the first branch attention feature of the first modal information and the first branch semantic feature of the first modal information and the second overall attention feature of the second modal information. Second attention information may be determined according to the second branch attention feature of the second modal information and the second branch semantic feature of the second modal information and the first overall attention feature of the first modal information. Then, the similarity between the first modal information and the second modal information may be determined according to the first attention information and the second attention information.

Here, the first attention information may be determined according to the first branch attention feature of the first modal information and the first branch semantic feature of the first modal information and the second overall attention feature of the second modal information as follows. Attention information of the second modal information for each information unit of the first modal information may be determined according to the first branch attention feature of the first modal information and the second overall attention feature of the second modal information. Then, the first attention information of the second modal information for the first modal information may be determined according to the attention information of the second modal information for the each information unit of the first modal information and the first branch semantic feature of the first modal information.

Correspondingly, the second attention information may be determined according to the second branch attention feature of the second modal information and the second branch semantic feature of the second modal information and the first overall attention feature of the first modal information as follows. Attention information of the first modal information for each information unit of the second modal information may be determined according to the second branch attention feature of the second modal information and the first overall attention feature of the first modal information. Then, the second attention information of the first modal information for the second modal information may be determined according to the attention information of the first modal information for the each information unit of the second modal information and the second branch semantic feature of the second modal information.

The process of determining the similarity between the first modal information and the second modal information is elaborated below with reference to FIG. 3. For example, the first modal information may be image information. The second modal information may be text information. After a first branch semantic feature vector Eᵥ, a first overall semantic feature vector e*ᵥ, a first branch attention feature vector Kᵥ, and a first overall attention feature vector k*ᵥ of the image information, as well as a second branch semantic feature vector Eₛ, a second overall semantic feature vector a second branch attention feature vector Kₛ, and a second overall attention feature vector k*ₛ of the text information have been acquired, attention information of the text information for each image unit of the image information may be determined first using k*ₛ and kᵥ. Then, a semantic feature of attention of the text information to the image information may be determined with reference to Eᵥ. That is, first attention information of the text information for the image information may be determined. The first attention information may be determined as shown in a formula (9).

$${\tilde{e}}_{v} = A ( {k}_{s}^{*} , {E}_{v} , {K}_{v} ) = softmax ( \frac{{k}_{s}^{\text{?}} {k}_{\text{?}}}{\sqrt{d}} ) {E}_{v}^{1} \\ \text{?} \text{indicates text missing or illegible when filed} \qquad ( 9 )$$

The A may represent an attention operation. The softmax may represent a normalized exponential function. The 1/\sqrt{d} may represent a control parameter capable of controlling a magnitude of attention. In this way, the acquired attention information may be made to stay within a proper range of magnitudes.

Correspondingly, the second attention information may be determined as shown in a formula (10).

$${\tilde{e}}_{s} = A ( {k}_{v}^{*} , {E}_{s} , {K}_{s} ) = softmax ( \frac{{k}_{s}^{\text{?}} {k}_{\text{?}}}{\sqrt{d}} ) {E}_{s}^{T} \\ \text{?} \text{indicates text missing or illegible when filed} \qquad ( 10 )$$

The A may represent an attention operation. The softmax may represent a normalized exponential function. The 1/\sqrt{d} may represent a control parameter.

After the first attention information and the second attention information have been acquired, a similarity between the image information and the text information may be computed according to a formula (11).

$$S ( V , S ) = \frac{S ( e \text{?} , {{e}^{\text{?}}}_{s} ) + S ( {{e}_{v}}^{\text{?}} , e \text{?} )}{2} \\ \text{?} \text{indicates text missing or illegible when filed} \qquad ( 11 )$$

The Se₁, e₁)=norm(e₁)norm(e₂)^{T}. the norm(*) may represent an operation of taking a norm.

With the formula, the similarity between the first modal information and the second modal information may be acquired.

By way of the cross-modal information retrieval, an attention feature may be decoupled from a semantic feature of modal information, and processed as a separate feature. In addition, the similarity between the first modal information and the second modal information may be determined with low time complexity, improving efficiency in cross-modal information retrieval.

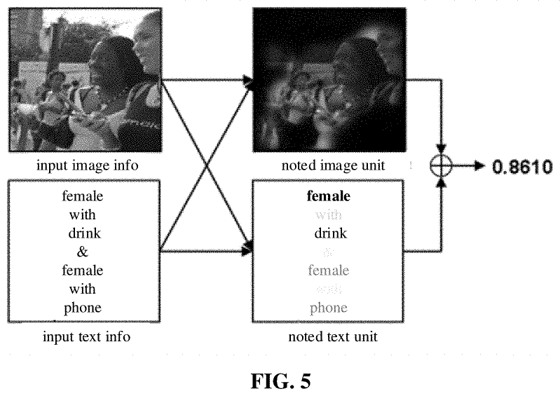

FIG. 5 is a block diagram of determining a matching retrieval result according to a similarity according to an exemplary embodiment herein. The first modal information and the second modal information may be image information and text information, respectively. Due to an attention mechanism during cross-modal information retrieval, during cross-modal information retrieval, more attention may be paid to a unit in the image information corresponding to a text unit in the text information, and more attention may be paid to a unit in the text information corresponding to an image unit in the image information. As shown in FIG. 5, image units “female”, “drink”, and “phone” in the image information are highlighted, and text units “female”, “drink”, and “phone” in the text information are highlighted.

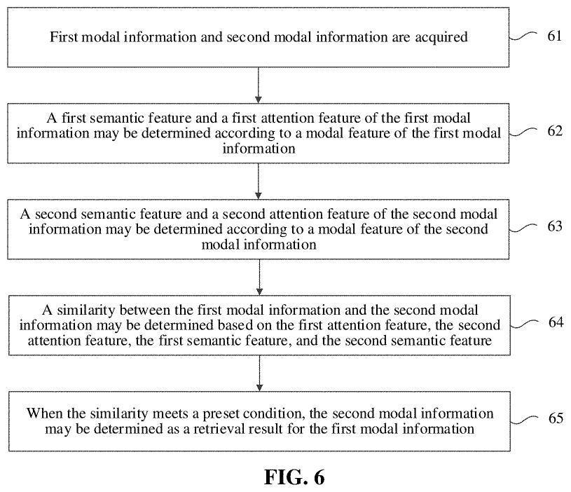

By way of the cross-modal information retrieval, embodiments herein further provide an example of applying cross-modal information retrieval. FIG. 6 is a flowchart of cross-modal information retrieval according to an exemplary embodiment herein. The first modal information may be to-be-retrieved information of a first mode. The second modal information may be pre-stored information of a second mode. The method for cross-modal information retrieval may include a step (steps) as follows.

In 61, first modal information and second modal information are acquired.

In 62, a first semantic feature of the first modal information and a first attention feature of the first modal information may be determined according to a modal feature of the first modal information.

In 63, a second semantic feature of the second modal information and a second attention feature of the second modal information may be determined according to a modal feature of the second modal information.

In 64, a similarity between the first modal information and the second modal information may be determined based on the first attention feature, the second attention feature, the first semantic feature, and the second semantic feature.

In 65, when the similarity meets a preset condition, the second modal information may be determined as a retrieval result for the first modal information.

Here, a retrieval device may acquire first modal information input by a user, and then may acquire second modal information from a local storage or a database. When the similarity between the first modal information and the second modal information meets the preset condition, the second modal information may be determined as a retrieval result for the first modal information.

In a possible implementation, there may be multiple pieces of the second modal information. When the second modal information is determined as the retrieval result for the first modal information, a ranking result may be acquired by ranking the multiple pieces of the second modal information according to a similarity between the first modal information and each of the multiple pieces of the second modal information. Then, second modal information meeting the preset condition may be determined according to the ranking result of ranking the second modal information. Then, the second modal information with a similarity meeting the preset condition may be determined as the retrieval result for the first modal information.

Here, the preset condition may include any one of:

the similarity being greater than a preset value, or a rank of the similarity acquired by ranking similarities in an ascending order being greater than a preset rank.

For example, in determining the second modal information as the retrieval result for the first modal information, if the similarity between the first modal information and the second modal information is greater than a preset value, the second modal information may be determined as a retrieval result for the first modal information. Alternatively, in determining the second modal information as the retrieval result for the first modal information, a ranking result may be acquired by ranking the multiple pieces of the second modal information by ranking similarities in an ascending order according to a similarity between the first modal information and each of the multiple pieces of the second modal information. Then, according to the ranking result, second modal information with a rank of a similarity thereof being greater than a preset rank may be determined as the retrieval result for the first modal information. For example, second modal information with a highest rank may be determined as the retrieval result for the first modal information. That is, the second modal information with the greatest similarity may be determined as the retrieval result for the first modal information. Here, there may be one or more retrieval results.

Here, after the second modal information has been determined as the retrieval result for the first modal information, the retrieval result may be output to a user terminal. For example, the retrieval result may be sent to the user terminal. Alternatively, the retrieval result may be displayed on a display interface.

By way of the cross-modal information retrieval, embodiments herein further provide an example of training cross-modal information retrieval. The first modal information may be training sample information of a first mode. The second modal information may be training sample information of a second mode. Each piece of the training sample information of the first mode and each piece of the training sample information of the second mode may form a training sample pair. During training, each training sample pair may be input to a cross-modal information retrieval model. A CNN, a Recurrent Neural Network (RNN), or a GRU may be selected to perform modal feature extraction on the first modal information or the second modal information. Then, using the cross-modal information retrieval model, a modal feature of the first modal information may be linearly mapped, acquiring a first semantic feature of the first modal information and a first attention feature of the first modal information, and a modal feature of the second modal information may be linearly mapped, acquiring a second semantic feature of the second modal information and a second attention feature of the second modal information. Next, using the cross-modal information retrieval model, the similarity between the first modal information and the second modal information may be acquired from the first attention feature, the second attention feature, the first semantic feature, and the second semantic feature. After similarities of multiple training sample pairs have been acquired, a loss of the cross-modal information retrieval model may be acquired using a loss function, such as a contrastive loss function, a hardest negative sample ranking loss function, etc. Then, a model sampling parameter of the cross-modal information retrieval model may be adjusted using the acquired loss, acquiring the cross-modal information retrieval model for cross-modal information retrieval.

By way of the cross-modal information retrieval, an attention feature may be decoupled from a semantic feature of modal information, and processed as a separate feature. In addition, the similarity between the first modal information and the second modal information may be determined with low time complexity, improving efficiency in cross-modal information retrieval.

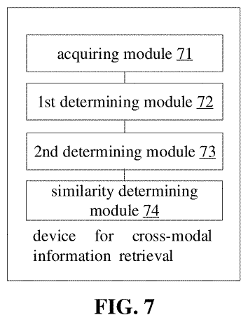

FIG. 7 is a block diagram of a device for cross-modal information retrieval according to an exemplary embodiment herein. As shown in FIG. 7, the device for cross-modal information retrieval includes an acquiring module, a first determining module, a second determining module, and a similarity determining module.

The acquiring module 71 is adapted to acquiring first modal information and second modal information.

The first determining module 72 is adapted to determining a first semantic feature of the first modal information and a first attention feature of the first modal information according to a modal feature of the first modal information.

The second determining module 73 is adapted to determining a second semantic feature of the second modal information and a second attention feature of the second modal information according to a modal feature of the second modal information.

The similarity determining module 74 is adapted to determining a similarity between the first modal information and the second modal information based on the first attention feature, the second attention feature, the first semantic feature, and the second semantic feature.

In a possible implementation, the first semantic feature may include a first branch semantic feature and a first overall semantic feature.

The first attention feature may include a first branch attention feature and a first overall attention feature.

The second semantic feature may include a second branch semantic feature and a second overall semantic feature. The second attention feature may include a second branch attention feature and a second overall attention feature.

In a possible implementation, the first determining module 72 may include a first dividing sub-module, a first mode determining sub-module, a first branch semantics extracting sub-module, and a first branch attention extracting sub-module.

The first dividing sub-module may be adapted to dividing the first modal information into at least one information unit.

The first mode determining sub-module may be adapted to determining a first modal feature of each information unit of the at least one information unit by performing first modal feature extraction on the each information unit.

The first branch semantics extracting sub-module may be adapted to extracting the first branch semantic feature in a semantic feature space based on the first modal feature of the each information unit.

The first branch attention extracting sub-module may be adapted to extracting the first branch attention feature in an attention feature space based on the first modal feature of the each information unit.

In a possible implementation, the device may further include a first overall semantic determining sub-module and a first overall attention determining sub-module.

The first overall semantic determining sub-module may be adapted to determining the first overall semantic feature of the first modal information according to the first branch semantic feature of the each information unit.

The first overall attention determining sub-module may be adapted to determining the first overall attention feature of the first modal information according to the first branch attention feature of the each information unit.

In a possible implementation, the second determining module 73 may include a second dividing sub-module, a second mode determining sub-module, a second branch semantics extracting sub-module, and a second branch attention extracting sub-module.

The second dividing sub-module may be adapted to dividing the second modal information into at least one information unit.

The second mode determining sub-module may be adapted to determining a second modal feature of each information unit of the at least one information unit by performing second modal feature extraction on the each information unit.

The second branch semantics extracting sub-module may be adapted to extracting the second branch semantic feature in a semantic feature space based on the second modal feature of the each information unit.

The second branch attention extracting sub-module may be adapted to extracting the second branch attention feature in an attention feature space based on the second modal feature of the each information unit.

In a possible implementation, the device may further include a second overall semantic determining sub-module and a second overall attention determining sub-module.

The second overall semantic determining sub-module may be adapted to determining the second overall semantic feature of the second modal information according to the second branch semantic feature of the each information unit.

The second overall attention determining sub-module may be adapted to determining the second overall attention feature of the second modal information according to the second branch attention feature of the each information unit.

In a possible implementation, the similarity determining module 74 may include a first attention information determining sub-module, a second attention information determining sub-module, and a similarity determining sub-module.

The first attention information determining sub-module may be adapted to determining first attention information according to the first branch attention feature of the first modal information and the first branch semantic feature of the first modal information and the second overall attention feature of the second modal information.

The second attention information determining sub-module may be adapted to determining second attention information according to the second branch attention feature of the second modal information and the second branch semantic feature of the second modal information and the first overall attention feature of the first modal information.

The similarity determining sub-module may be adapted to determining the similarity between the first modal information and the second modal information according to the first attention information and the second attention information.

In a possible implementation, the first attention information determining sub-module may specifically be adapted to:

determining attention information of the second modal information for each information unit of the first modal information according to the first branch attention feature of the first modal information and the second overall attention feature of the second modal information; and

determining the first attention information of the second modal information for the first modal information according to the attention information of the second modal information for the each information unit of the first modal information and the first branch semantic feature of the first modal information.

In a possible implementation, the second attention information determining sub-module may specifically be adapted to:

determining attention information of the first modal information for each information unit of the second modal information according to the second branch attention feature of the second modal information and the first overall attention feature of the first modal information; and

determining the second attention information of the first modal information for the second modal information according to the attention information of the first modal information for the each information unit of the second modal information and the second branch semantic feature of the second modal information.

In a possible implementation, the first modal information may be to-be-retrieved information of a first mode. The second modal information may be pre-stored information of a second mode. The device may further include a retrieval result determining module.

The retrieval result determining module may be adapted to, in response to the similarity meeting a preset condition, determining the second modal information as a retrieval result for the first modal information.

In a possible implementation, there may be multiple pieces of the second modal information. The retrieval result determining module may include a ranking sub-module, an information determining sub-module, and a retrieval result determining sub-module.

The ranking sub-module may be adapted to acquiring a ranking result by ranking the multiple pieces of the second modal information according to a similarity between the first modal information and each of the multiple pieces of the second modal information.

The information determining sub-module may be adapted to determining second modal information meeting the preset condition according to the ranking result.

The retrieval result determining sub-module may be adapted to determining the second modal information meeting the preset condition as the retrieval result for the first modal information.

In a possible implementation, the preset condition may include any one of:

the similarity being greater than a preset value, or a rank of the similarity acquired by ranking similarities in an ascending order being greater than a preset rank.

In a possible implementation, the device may further include an outputting module.

The outputting module may be adapted to outputting the retrieval result to a user terminal.

In a possible implementation, the first modal information may include any one of text information or image information. The second modal information may include any one of text information or image information.

In a possible implementation, the first modal information may be training sample information of a first mode. The second modal information may be training sample information of a second mode. Each piece of the training sample information of the first mode and each piece of the training sample information of the second mode may form a training sample pair.

Understandably, embodiments of a method herein may be combined with each other to form a combined embodiment as long as the combination does not go against a principle or a logic, which is not elaborated herein due to a space limitation.

In addition, embodiments herein further provide the abovementioned device, electronic equipment, a computer-readable storage medium, and a program, all of which may be adapted to implementing any method for cross-modal information retrieval provided herein. Refer to disclosure for a method herein for a technical solution thereof and description therefor, which is not elaborated.

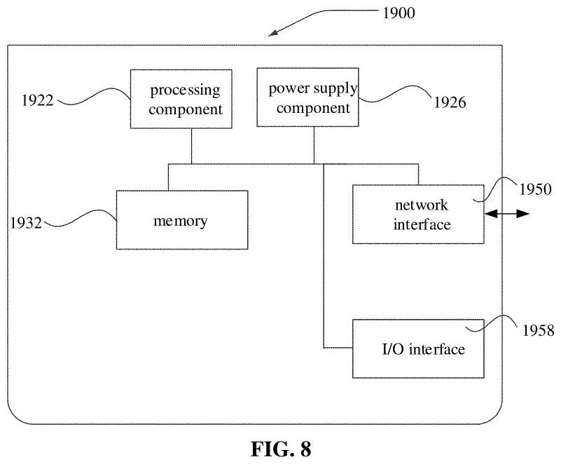

FIG. 8 is a block diagram of a device 1900 for cross-modal information retrieval according to an exemplary embodiment herein. For example, the device 1900 may be provided as an application server. Referring to FIG. 8, the device 1900 may include a processing component 1922. The processing component may include one or more processors. The device may include a memory resource represented by memory 1932. The memory may be adapted to storing an instruction executable by the processing component 1922, such as an APP. The APP stored in the memory 1932 may include one or more modules. Each of the modules may correspond to a group of instructions. In addition, the processing component 1922 may be adapted to executing instructions to perform a method herein.

The device 1900 may further include a power supply component 1926. The power supply component may be adapted to managing power of the device 1900. The device may further include a wired or wireless network interface 1950 adapted to connecting the device 1900 to a network. The device may further include an Input/Output (I/O) interface 1958. The device 1900 may operate based on an operating system stored in the memory 1932, such as a Windows Server™, a Mac OS X™, a Unix™, a Linux™, a FreeBSD™, etc.

According to an exemplary embodiment herein, a non-volatile computer-readable storage medium, such as the memory 1932 including computer program instructions, may be provided. The computer program instructions may be executed by the processing component 1922 of the device 1900 to implement a method herein.

The subject disclosure may be a system, a method, and/or a computer program product. The computer program product may include a computer-readable storage medium, having borne thereon computer-readable program instructions allowing a processor to implement various aspects herein.

A computer-readable storage medium may be tangible equipment capable of keeping and storing an instruction used by instruction executing equipment. For example, a computer-readable storage medium may be, but is not limited to, electric storage equipment, magnetic storage equipment, optical storage equipment, electromagnetic storage equipment, semiconductor storage equipment, or any appropriate combination thereof. A non-exhaustive list of more specific examples of a computer-readable storage medium may include a portable computer disk, a hard disk, Random Access Memory (RAM), Read-Only Memory (ROM), Erasable Programmable Read-Only Memory (EPROM, or flash memory), Static Random Access Memory (SRAM), Compact Disc Read-Only Memory (CD-ROM), a Digital Versatile Disk (DVD), a memory stick, a floppy disk, mechanical coding equipment such as a protruding structure in a groove or a punch card having stored thereon an instruction, as well as any appropriate combination thereof. A computer-readable storage medium used here may not be construed as a transient signal per se, such as a radio wave, another freely propagated electromagnetic wave, an electromagnetic wave propagated through a wave guide or another transmission medium (such as an optical pulse propagated through an optical fiber cable), or an electric signal transmitted through a wire.

A computer-readable program instruction described here may be downloaded from a computer-readable storage medium to respective computing/processing equipment, or to an external computer or external storage equipment through a network such as the Internet, a Local Area Network (LAN), a Wide Area Network (WAN), and/or a wireless network. A network may include a copper transmission cable, optical fiber transmission, wireless transmission, a router, a firewall, a switch, a gateway computer, and/or an edge server. A network adapter card or a network interface in respective computing/processing equipment may receive the computer-readable program instruction from the network, and forward the computer-readable program instruction to computer-readable storage media in respective computing/processing equipment.

A computer program instruction for implementing an operation herein may be an assembly instruction, an Instruction Set Architecture (ISA) instruction, a machine instruction, a machine related instruction, a microcode, a firmware instruction, state setting data, or a source code or object code written in any combination of one or more programming languages. A programming language may include an object-oriented programming language such as Smalltalk, C++, etc., as well as a conventional procedural programming language such as C or a similar programming language. Computer-readable program instructions may be executed on a computer of a user entirely or in part, as a separate software package, partly on the computer of the user and partly on a remote computer, or entirely on a remote computer/server. When a remote computer is involved, the remote computer may be connected to the computer of a user through any type of network including an LAN or a WAN. Alternatively, the remote computer may be connected to an external computer (such as connected through the Internet using an Internet service provider). In some embodiments, an electronic circuit such as a programmable logic circuit, a Field-Programmable Gate Array (FPGA), or a Programmable Logic Array (PLA) may be customized using state information of a computer-readable program instruction. The electronic circuit may execute the computer-readable program instruction, thereby implementing an aspect herein.

Aspects herein have been described with reference to flowcharts and/or block diagrams of the method, device (system), and computer program product herein. It is be understood that each block in the flowcharts and/or the block diagrams and a combination of respective blocks in the flowcharts and/or the block diagrams may be implemented by computer-readable program instructions.

These computer-readable program instructions may be provided to a general-purpose computer, an application-specific computer, or a processor of another programmable data processing device, thereby producing a machine to allow the instruction to produce, when executed through a computer or the processor of another programmable data processing device, a device implementing a function/move specified in one or more blocks in the flowcharts and/or the block diagrams. The computer-readable program instructions may also be stored in a computer-readable storage medium. The instructions allow a computer, a programmable data processing device and/or other equipment to work in a specific mode. Accordingly, the computer-readable medium including the instructions includes a manufactured article including instructions for implementing each aspect of a function/move specified in one or more blocks in the flowcharts and/or the block diagrams.

Computer-readable program instructions may also be loaded to a computer, another programmable data processing device, or other equipment, such that a series of operations are executed in the computer, the other programmable data processing device, or the other equipment to produce a computer implemented process, thereby allowing the instructions executed on the computer, the other programmable data processing device, or the other equipment to implement a function/move specified in one or more blocks in the flowcharts and/or the block diagrams.

The flowcharts and block diagrams in the drawings show possible implementation of architectures, functions, and operations of the system, method, and computer program product according to multiple embodiments herein. In this regard, each block in the flowcharts or the block diagrams may represent part of a module, a program segment, or an instruction. The part of the module, the program segment, or the instruction includes one or more executable instructions for implementing a specified logical function. In some alternative implementations, functions noted in the blocks may also occur in an order different from that noted in the drawings. For example, two consecutive blocks may actually be implemented basically in parallel. They sometimes may also be implemented in a reverse order, depending on the functions involved. Also note that each block in the block diagrams and/or the flowcharts, as well as a combination of the blocks in the block diagrams and/or the flowcharts, may be implemented by a hardware-based application-specific system for implementing a specified function or move, or by a combination of an application-specific hardware and a computer instruction.

Description of embodiments herein is exemplary, not exhaustive, and not limited to the embodiments disclosed herein. Various modification and variations can be made without departing from the principle of embodiments herein. The modification and variations will be apparent to a person having ordinary skill in the art. Choice of a term used herein is intended to best explain the principle and/or application of the embodiments, or improvement to technology in the market, or allow a person having ordinary skill in the art to understand the embodiments disclosed herein.

What is claimed is:

1. A method for cross-modal information retrieval, comprising:
acquiring first modal information and second modal information;
determining a first semantic feature of the first modal information and a first attention feature of the first modal information according to a modal feature of the first modal information;
determining a second semantic feature of the second modal information and a second attention feature of the second modal information according to a modal feature of the second modal information; and
determining a similarity between the first modal information and the second modal information based on the first attention feature, the second attention feature, the first semantic feature, and the second semantic feature.

2. The method of claim 1,
wherein the first semantic feature comprises a first branch semantic feature and a first overall semantic feature, wherein the first attention feature comprises a first branch attention feature and a first overall attention feature,
wherein the second semantic feature comprises a second branch semantic feature and a second overall semantic feature, wherein the second attention feature comprises a second branch attention feature and a second overall attention feature.

3. The method of claim 2, wherein determining the first semantic feature of the first modal information and the first attention feature of the first modal information according to the modal feature of the first modal information comprises:
dividing the first modal information into at least one information unit;
determining a first modal feature of each information unit of the at least one information unit by performing first modal feature extraction on the each information unit;
extracting the first branch semantic feature in a semantic feature space based on the first modal feature of the each information unit; and
extracting the first branch attention feature in an attention feature space based on the first modal feature of the each information unit.

4. The method of claim 3, further comprising:
determining the first overall semantic feature of the first modal information according to the first branch semantic feature of the each information unit; and
determining the first overall attention feature of the first modal information according to the first branch attention feature of the each information unit.

5. The method of claim 2, wherein determining the second semantic feature of the second modal information and the second attention feature of the second modal information according to the modal feature of the second modal information comprises:
dividing the second modal information into at least one information unit;
determining a second modal feature of each information unit of the at least one information unit by performing second modal feature extraction on the each information unit;
extracting the second branch semantic feature in a semantic feature space based on the second modal feature of the each information unit; and
extracting the second branch attention feature in an attention feature space based on the second modal feature of the each information unit.

6. The method of claim 5, further comprising:
determining the second overall semantic feature of the second modal information according to the second branch semantic feature of the each information unit; and
determining the second overall attention feature of the second modal information according to the second branch attention feature of the each information unit.

7. The method of claim 2, wherein determining the similarity between the first modal information and the second modal information based on the first attention feature, the second attention feature, the first semantic feature, and the second semantic feature comprises:
determining first attention information according to the first branch attention feature of the first modal information and the first branch semantic feature of the first modal information and the second overall attention feature of the second modal information;
determining second attention information according to the second branch attention feature of the second modal information and the second branch semantic feature of the second modal information and the first overall attention feature of the first modal information; and
determining the similarity between the first modal information and the second modal information according to the first attention information and the second attention information.

8. The method of claim 7, wherein determining the first attention information according to the first branch attention feature of the first modal information and the first branch semantic feature of the first modal information and the second overall attention feature of the second modal information comprises:
determining attention information of the second modal information for each information unit of the first modal information according to the first branch attention feature of the first modal information and the second overall attention feature of the second modal information; and
determining the first attention information of the second modal information for the first modal information according to the attention information of the second modal information for the each information unit of the first modal information and the first branch semantic feature of the first modal information.

9. The method of claim 7, wherein determining the second attention information according to the second branch attention feature of the second modal information and the second branch semantic feature of the second modal information and the first overall attention feature of the first modal information comprises:
determining attention information of the first modal information for each information unit of the second modal information according to the second branch attention feature of the second modal information and the first overall attention feature of the first modal information; and
determining the second attention information of the first modal information for the second modal information according to the attention information of the first modal information for the each information unit of the second modal information and the second branch semantic feature of the second modal information.

10. The method of claim 1, wherein the first modal information is to-be-retrieved information of a first mode, wherein the second modal information is pre-stored information of a second mode, wherein the method further comprises:
in response to the similarity meeting a preset condition, determining the second modal information as a retrieval result for the first modal information.

11. The method of claim 10, wherein there are multiple pieces of the second modal information, wherein in response to the similarity meeting the preset condition, determining the second modal information as the retrieval result for the first modal information comprises:
acquiring a ranking result by ranking the multiple pieces of the second modal information according to a similarity between the first modal information and each of the multiple pieces of the second modal information;
determining second modal information meeting the preset condition according to the ranking result; and
determining the second modal information meeting the preset condition as the retrieval result for the first modal information.

12. The method of claim 11, wherein the preset condition comprises any one of:
the similarity being greater than a preset value, or a rank of the similarity acquired by ranking similarities in an ascending order being greater than a preset rank.

13. The method of claim 10, further comprising: after determining the second modal information as the retrieval result for the first modal information,
outputting the retrieval result to a user terminal.

14. The method of claim 1, wherein the first modal information comprises any one of text information or image information, wherein the second modal information comprises any one of the text information or the image information.

15. The method of claim 1, wherein the first modal information is training sample information of a first mode, wherein the second modal information is training sample information of a second mode, wherein each piece of the training sample information of the first mode and each piece of the training sample information of the second mode form a training sample pair.

16. A device for cross-modal information retrieval, comprising a processor and memory,
wherein the memory is adapted to storing an instruction executable by the processor,
wherein the processor is adapted to executing the executable instruction stored in the memory to implement:
acquiring first modal information and second modal information;
determining a first semantic feature of the first modal information and a first attention feature of the first modal information according to a modal feature of the first modal information;
determining a second semantic feature of the second modal information and a second attention feature of the second modal information according to a modal feature of the second modal information; and
determining a similarity between the first modal information and the second modal information based on the first attention feature, the second attention feature, the first semantic feature, and the second semantic feature.

17. The device of claim 16,
wherein the first semantic feature comprises a first branch semantic feature and a first overall semantic feature, wherein the first attention feature comprises a first branch attention feature and a first overall attention feature,
wherein the second semantic feature comprises a second branch semantic feature and a second overall semantic feature, wherein the second attention feature comprises a second branch attention feature and a second overall attention feature.

18. The device of claim 17, wherein the processor is adapted to determining the first semantic feature of the first modal information and the first attention feature of the first modal information according to the modal feature of the first modal information, by:
dividing the first modal information into at least one information unit;
determining a first modal feature of each information unit of the at least one information unit by performing first modal feature extraction on the each information unit;
extracting the first branch semantic feature in a semantic feature space based on the first modal feature of the each information unit; and
extracting the first branch attention feature in an attention feature space based on the first modal feature of the each information unit.

19. The device of claim 18, wherein the processor is adapted to:
determining the first overall semantic feature of the first modal information according to the first branch semantic feature of the each information unit; and
determining the first overall attention feature of the first modal information according to the first branch attention feature of the each information unit.

20. A non-transitory computer-readable storage medium, having stored therein computer program instructions which, when executed by a processor, implement:
acquiring first modal information and second modal information;
determining a first semantic feature of the first modal information and a first attention feature of the first modal information according to a modal feature of the first modal information;
determining a second semantic feature of the second modal information and a second attention feature of the second modal information according to a modal feature of the second modal information; and
determining a similarity between the first modal information and the second modal information based on the first attention feature, the second attention feature, the first semantic feature, and the second semantic feature.
